(19) United States
(12) Patent Application Publication
(10) Pub. No.: US 2009/0313674 A1
(43) Pub. Date: Dec. 17, 2009

(54) PID Obfuscation

(75) Inventors: Edward Ludvig, Redwood City, CA (US); Donald J. Fossgreen, Scotts Valley, CA (US); Jeremy Edmonds, Campbell, CA (US); Gregory E. Brown, Fremont, CA (US); Arleen Fernando, Redwood City, CA (US)

Correspondence Address: Sunstein Kann Murphy & Timbers LLP, 125 SUMMER STREET, BOSTON, MA, 02110-1618, US

(73) Assignee: ICTV, INC., San Jose, CA (US)

(21) Appl. No.: 12/140,857

(22) Filed: Jun. 17, 2008

(51) Int. Cl. H04N 7/173; H04N 11/02

(52) U.S. Cl. 725/118; 375/240.01; 375/E07.001

(57) ABSTRACT

A method, system, and computer program product for providing a decoy identifier, such as an MPEG PID, for a non-encrypted component. By obscuring the true identifier, an MPEG receiver that can decode ‘clear channels’ can not locate, and therefore, can not decode and present the true component for the program to a display device. By using the disclosed methodology, computer program product and system a cable television system or other provider of individualized content can broadcast a requested component without needing to encrypt the component.

### TECHNICAL FIELD

The present invention relates to television systems and more specifically to television systems that include MPEG receivers.

### BACKGROUND ART

It is known in the prior art to broadcast television content in digital format using the MPEG protocol. In particular cable systems employ MPEG in order to compress digital programs. The MPEG protocol allows for the multiplexing of audio and video, such that multiple audio and video programs may be transmitted simultaneously in a transport stream.

The transport stream includes a program association table (PAT). The PAT lists all of the identifiers (PIDs) for each program map table (PMT) associated with a program. The PAT information always has PID 0x0 within the transport stream. Each program within the transport stream includes a program map table (PMT), which has its own unique PID. The PMT describe a program's constituent components (elementary streams and their associated PIDs. PMTs also include a description of the elementary streams. For example, a PMT for a program may include a single video source that is associated with multiple audio sources. The audio sources may be audio content associated with the video source in different languages (English, Spanish, French). Each stream within a transport stream is identified by a PID (packet identifier).

Digital tuners are capable of reading and decoding MPEG programs within transport streams that are “clear.” A clear program is a program that is not encrypted. Television manufacturers have begun integrating digital tuners into televisions and digital tuners are now sold as standalone products to be coupled to computers and televisions. Examples of digital tuners include QAM tuners, QPSK tuners, and IPTV tuners that demultiplex and decode MPEG elementary streams.

Digital tuners access both the PAT and the PMTs in order to provide users with access to programs within the transport stream and identify a channel line-up. Digital tuners default to the first listed components or components with the lowest video and audio PIDs for a program within the PMT. Thus, if there are three audio streams associated with a program, the QAM tuner will by default access the first listed audio component or audio component with the lowest PID.

Users can generally configure a receiver with their user preferences. A user may desire to hear the audio in Spanish and the receiver may allow the user to select a preference through a settings or preferences user interface displayed on the user's television or computer monitor. Thus, based upon the user's preference, the receiver would review the PMT and identify and select the audio elementary stream whose descriptor (e.g. SP, LN-SP) matched the receiver language setting. This preference setting is done prior to receipt of the transport stream. While typically only a single video component is associated with a program, it is possible to have multiple video components declared in a PMT. In this case, by default, a digital tuner would acquire the first video component or video component with the lowest value PID listed in the PMT by default.

### SUMMARY OF THE INVENTION

A method, system, and computer program product for adding a decoy identifier, such as an MPEG PID for a non-encrypted component of a program is disclosed. By obscuring the true identifier, an MPEG receiver that can decode ‘clear channels’ can not locate and therefore, can not decode and present the true component for the program. By using the disclosed methodology, a cable television system or other provider of individualized content can broadcast a requested component without needing to encrypt the component.

In order to obscure a true component from an MPEG receiver, a transport stream is created containing a program map table for at least one program containing the true component. A decoy identifier is inserted into the program map where the program map also includes an identifier for the true component. The decoy identifier is an identifier that the MPEG receiver will use by default as opposed to the identifier for the true component. For example, a QAM tuner defaults to the lowest PID number for a component. Thus, by inserting a decoy PID as the decoy identifier that has a lower value than the PID of the true component, a QAM tuner will not decode and present the true component. Instead, the QAM tuner will attempt to decode and present any data that is associated with the decoy identifier. In other embodiments, an MPEG receiver may default to the first PID for a component that is listed in each component category. In such an embodiment, the decoy PID would be inserted into the first position for one or more component categories.

The decoy identifier may have associated data or no associated data. If associated data for the decoy identifier is provided then the MPEG receiver will decode and present this data. This data may be a message to the user of the MPEG receiver that the channel requires subscription in order to be used. If there is no data associated with the decoy identifier, the decoy component for the decoy identifier will be considered a null set. A program association table containing a listing of identifiers for each program map table will be included in the transport stream.

In addition, a requesting client device within the communication network that has requested interactive/individualized content will also receive the same transport stream. However, the requesting client device will have received the true identifier associated with the true component for the program and will therefore use the received identifier for locating the data corresponding to the true component, rather than using the decoy identifier. In some embodiments, the client device, which may be a set-top box, parses the transport stream to identify the program access table and the program map table for the program. The client device can then confirm that the identifier that it previously received exists within the program map table. In other embodiments, the client device has a program for selecting the true identifier and avoiding the decoy identifier. Thus, in this embodiment, the client device does not receive the true identifier from the processing office.

Prior to receiving a transport stream, the client device requesting the interactive/individualized content will negotiate a connection with the processing office. The client device will then request an interactive session. The processing office in response to the request for an interactive session will send one or more identifiers to the client device which are to be used to identify the true component within the transport stream. It should be obvious to one of ordinary skill that the system and methodology can be used for different component types including audio, video and data.

Thus, a user that requests an interactive/individualized component from a processing office will be able to locate the true component within the transmitted video transport stream while all other video receivers will use the decoy identifier and therefore, these receivers will not decode and present the true component.

### BRIEF DESCRIPTION OF THE DRAWINGS

The foregoing features of the invention will be more readily understood by reference to the following detailed description, taken with reference to the accompanying drawings, in which:

FIG. 1 is an exemplary system for providing interactive content to a cable television user;

FIG. 2 shows an exemplary program map table;

FIG. 3 is a flow chart of one embodiment of the invention for creating a program map table with an obfuscated video elementary stream;

FIG. 4 is a flow chart of the process of locating an obscured non-encrypted program; and

FIG. 4A is an alternative embodiment of the flow chart of FIG. 4.

### DETAILED DESCRIPTION OF SPECIFIC EMBODIMENTS

QAM tuners are known to those of ordinary skill in the art as devices that can receive and decode unencrypted MPEG transport streams that have been Quadrature Amplitude Modulated within a channel. Embodiments of the invention provide for obscuring a video identifier, such as a PID, within an MPEG transport stream from a QAM tuner. Obscuring the identifier is accomplished by including a packet identifier (PID) that is different from the PID for the video component for the program. The QAM tuner will default to presentation of the lowest number PID for a given component and therefore, the QAM tuner will display a blank screen on a display device if no data is associated with the obscuring PID or the QAM tuner will display a message or pattern that is not the video component for the program. PID obfuscation is useful for cable television providers, satellite television providers, and other content distribution systems that distribute content using MPEG transport streams that wish to broadcast content for which a premium is to be charged without the need for scrambling the elementary stream data. This is particularly useful in real-time systems with interactive content that are highly processor intensive. If a requesting user of an interactive session is properly authorized, the set-top box or other client device interface with the communication network providing the interactive content will already know the PID number of the interactive elementary program stream and thus, will receive and display the interactive elementary stream on the user's display device. A round-trip transaction between a user requesting interactive content and a processing office providing the interactive content is shortened in temporal length by removing the descrambling process from the transaction. Although QAM or Quadrature Amplitude Modulated tuners are used as examples within the description other devices that decode MPEG transport streamers may be used. It should be recognized by one of ordinary skill in the art that the video, audio, and other data are each referred to as components of a program. Therefore, a program generally includes at least a video component and an audio component.

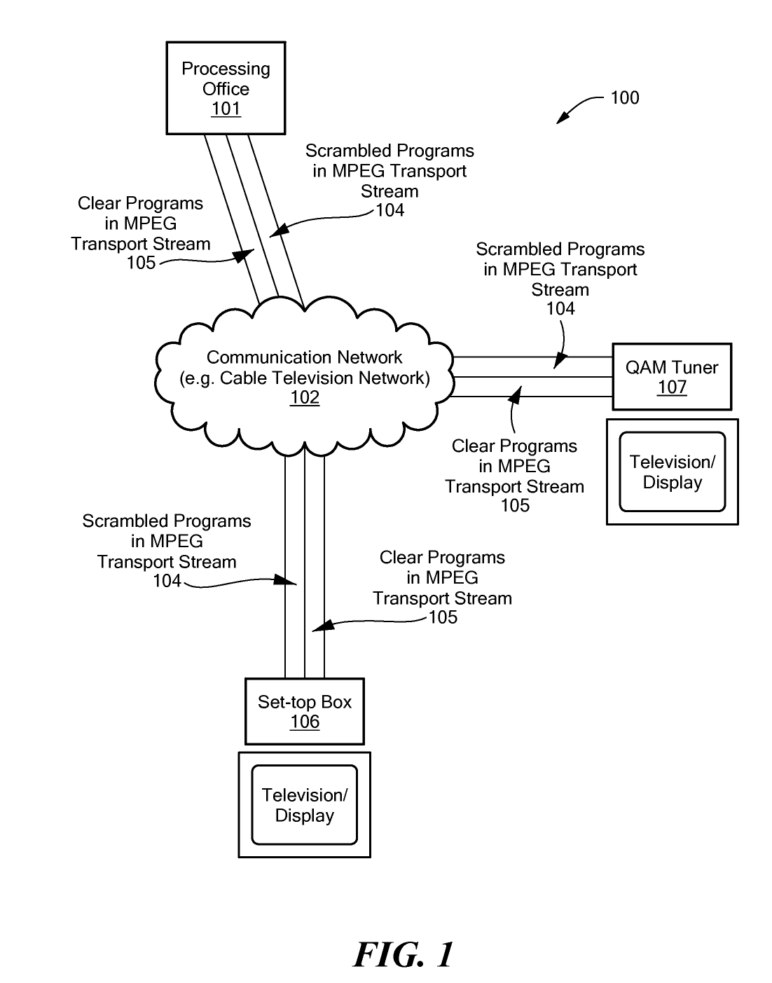

FIG. 1 shows an environment 100 for implementing the present invention. As shown, a processing office 101, such as a cable headend, is coupled through a communication network 102 to a plurality of users' televisions 103a, 103b. The communication network 102 may be a wired network, such as a cable network or IP television network, or the network may be wireless, such as a satellite network. The processing office 101 provides programming through the communication network 102 by transmitting one or more MPEG transport stream over selected frequencies. Each program within the MPEG transport stream may be made up of one or more elementary streams which may be referred to as components. For example, a program may have a video elementary stream and two audio elementary streams associated with the program wherein one of the audio elementary streams is an English language version of the program and the second audio elementary stream is a Spanish language version of the program.

An MPEG transport stream generally contains multiple programs and contains multiple elementary streams. The streams are modulated on a carrier for transmission over the communication network. The transport stream contains both encrypted (i.e. scrambled) 104 programs and also unencrypted programs 105. The unencrypted programs can be viewed by any device that can demodulate the signal on the carrier and decode the MPEG transport stream. The encrypted programs can only be decrypted by a device having the decryption key that includes either an arithmetic logic unit for decrypting the program or a general processor that executes an encryption decoder. The encryption scheme may be any encryption scheme known within the art for encrypting data.

As an example, in a cable television network, a subscriber that has subscribed to a premium channel will be provided with an electronic device 106 including a decoder for decoding the MPEG transport stream. A channel/program is selected by a user using an input device in communication with the electronic device. The electronic device has previously received a channel map that maps a channel number/program to both the frequency to demodulate and the packet identifier (PID). The channel map table may be received out of band by the electronic device 106. The electronic device 106 will demodulate the frequency containing the transport stream for the program. The decoder within the electronic device will identify all of the programs and corresponding elementary streams for the programs within the MPEG transport stream and will locate the PID associated with the desired program. Additionally, the electronic device (e.g. set-top box) 106 will contain either an ALU or the decryption code with a processor, such as a set-top box. The subscriber's electronic device will be provided with the keys to decrypt the premium channels that the subscriber has requested. Thus, some of the elementary streams within the transport stream may be viewed without decryption (i.e., clear channel/programs) and the premium programs require decryption. A user of the system that has not paid for premium content may also have a set-top box or other decoding device (e.g. a cable card) 107 for decoding the MPEG transport stream. The set-top box may contain a QAM (quadrature amplitude modulation) tuner for demodulating and decoding the MPEG transport stream. The user may also have a stand-alone QAM tuner or a QAM tuner may be built into the user's television. The QAM tuner 107 provides the non-subscriber with the ability to decode the “clear” QAM channels i.e. the channels that have not been encrypted. The QAM tuner 107 provides the user with a channel listing and associated program identifiers. The QAM tuner 107 also tunes to the selected channels for the user.

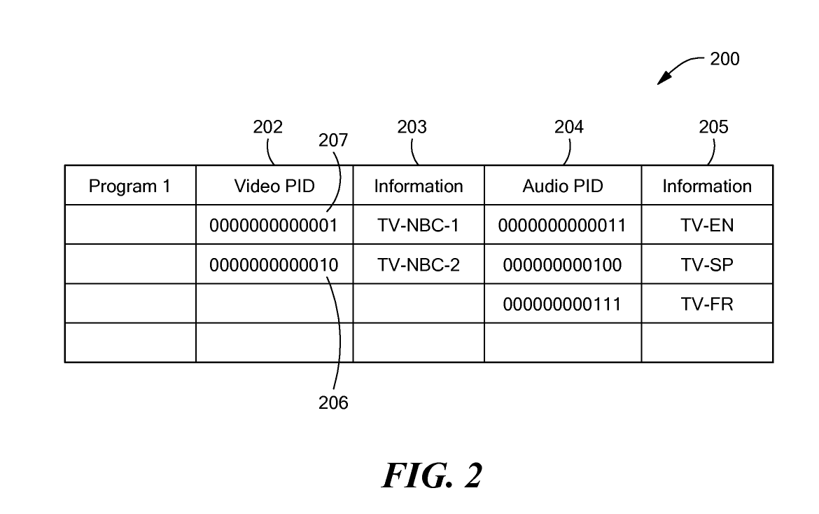

The MPEG transport stream in addition to containing the elementary streams for the programs also includes a program association table to identify the programs within the transport stream. The program association table or PAT is located at identifier 0x000 (PID 0). The program association table also includes the PIDs for each program map table (PMT). Each program within the transport stream contains its own PMT. As shown in FIG. 2, the PMT 200 for a program includes at least a listing of the PIDs for each video and audio elementary stream that is located within the transport stream. The PID for an elementary stream (component) can be used to demultiplex the elementary stream from the transport stream. The PMT also includes information about the elementary stream (e.g. a video elementary stream may be an MPEG-2 stream and an audio elementary stream may be encoded using AC-3). The PMT may also include other program information, such as a designation as to origination or a description of the program 203, 205.

Auto-scanning MPEG receivers, such as QAM tuners scan the digital spectrum such as broadcast TV spectrum and auto-discover digital services in the digital TV spectrum and assign these digital services to channels that then become tunable (available) from the receiver. The creation of a channel index may be stored by the QAM tuner or the television. With respect to MPEG transport streams, QAM tuner operates in the following manner. First, the transport stream is identified and the PAT is located at PID 0 (0x000). From the PAT each of the PMTs is identified and a program table is created with the channel assignments for each program. When a user changes channels using a remote control, the QAM tuner defaults to the lowest PID within each component category (e.g. video, audio) 202, 204. Thus, the QAM tuner will decode the MPEG components for the selected program using an MPEG decoder. Based upon the PID associated with that program the lowest PID number for the video and audio components will be decoded. In other embodiments, the MPEG receiver will default to the first listed PID within each component category as opposed to the lowest number PID. In some instances, a user will be able to identify a specific stream type that the user wishes to have decoded rather than the lowest PID prior to receiving the transport stream. For example, the user can indicate prior to the QAM tuner receiving the MPEG transport stream that the user is interested in receiving the audio as AC-3 and in Spanish. The QAM tuner will be provided with this information either directly or indirectly through interaction with a processor and memory that holds this information. The QAM tuner will then search in the information section 205 of the PMT to locate any identifier as to Spanish, such as SP or SP-TV that also includes the designation AC-3.

In one embodiment, the processing office includes a system that assigns a processor, such as a desktop computer processor, based upon a request for an interactive session from a client device. During the negotiation between the client device and the processor establishing a connection, the processor passes information regarding the PIDs for the components of an interactive program. The processor may provide a PID identifier for the program map table (PMT) and may also pass component PIDs to the client device that will be associated with the interactive session. The interactive components are not be encrypted. The client device stores the PID(s) in memory and waits for the interactive content. The processor at the processing office obtains the requested video content and creates a series of frames of MPEG content. The frames may contain content from multiple sources, for example a background/layout may be stored locally at the processing office and a broadcast program or pre-recorded program may be obtained from another source that is not local to the processing office. The content if not already in the MPEG format is converted to a series of MPEG macroblocks. The background macroblocks and the broadcast program macroblocks are then stitched together. The stitched MPEG video frames form an elementary stream. Each of the frames may be created in accordance with the techniques explained in U.S. patent application Ser. No. 12/008,697 and 12/008,722 both of which were filed January 11, 2008 and both of which are incorporated herein by reference in their entirety, although other techniques for creating interactive content may also be used. By foregoing the need to encrypt the interactive content that is being created in response to user's requests, real-time or near real-time (minimal millisecond/delays) interactions can occur.

The processor outputs the video and corresponding audio elementary streams for the program. The processing office assigns PIDs to the elementary streams. For example, a processing module that includes MPEG multiplexing functionality may assign PIDs to each elementary stream, program map table, and program association table. The PID for the video component is the same PID number as that which was previously sent to the client device. Additionally, the processing office creates another video PID for the interactive program in order to obscure the video PID associated with the interactive video and audio components from a receiving QAM tuner. This created video PID is provided with a lower PID number than the PID sent to the client device and thus, this video PID will be the decoy PID for a QAM tuner. In other embodiments, in which the MPEG receiver defaults to the first PID in each component category within the PMT, the processing office places the decoy PID into the first position. The processing office may also associate packet data with the decoy PID used for obfuscation. For example, a video component associated with the decoy PID produces a static image containing content such as “Access to this channel is prohibited without a subscription.” This alternative approach helps elude those auto-scanning QAM receivers and other tuners that implement algorithms that would otherwise ignore any program component PIDs that reference in existent packets and are able to auto-discover the true component PIDs. The disclosed system and methodology prevents a user from viewing another user's interactive content. The elementary streams forming the programs are then multiplexed together into a transport stream.

The processing office creates a PAT and then a PMT for each program. The PMT for the interactive program will contain the PIDs for the interactive content 206 along with the PID for misdirection 207. It should be noted that the invention may be embodied in any system that creates an MPEG transport stream and the corresponding PAT and PMTs for programs and is not limited by the above described interactive system and environment.

The processing office transmits the transport stream through the communication network and the client device receives the modulated transport stream. The transport stream is demodulated and decoded by the client device. The client device uses the previously received PIDs to select the elementary stream containing the interactive content to decode. The interactive elementary stream is decoded using an MPEG decoder and the resulting digital information is provided to a display or television. The client program running on the client device for interactive session control interfaces with firmware with the client device (e.g. set-top box). The client program may run directly on top of the client device's operating system or on a middleware layer that abstracts the client device's controls through an API. Control can also be achieved by writing directly into hardware control registers if the client device allows.

In an alternative embodiment, when an interactive session is established, the processing office adds a private descriptor to the PMT for the program e.g. “interactive video.” The client program running on the client device will search for and locate the private descriptor within the PMT. Once the private description is located, the client device will use the associated PID of the private descriptor to access the interactive elementary stream. Thus, the client program will automatically skip the decoy elementary stream for the program and will display the interactive content without the PID for the interactive component needing to be forwarded to the client device prior to receipt of the transport stream.

In another embodiment, only the PID for the interactive video content is transmitted by the assigned processor prior to transmission of the transport stream and not the PID for the PMT. The client device can call a component API or simply load a video packet filter with the PID and the client device will decode and present the video component associated with the PID without accessing the PMT. The PID may also be included within the transport stream in a transport stream header and the client device may use the PID in the transport stream to locate the interactive video component without prior transmission of the PID to the client device. A private table may also be included or another datagram either-in-band or out-of-band may include the PID. Thus in these embodiments, the PID is not part of the PMT. Although not including the PID within a standard PMT is possible and presentation of the video component may occur, the PID associated with the video component may be used by another piece of equipment within the communications network causing an error in display by the presenting display device. Thus, a PID collision may occur causing both video component data and other data to be decoded and presented in error. Remapping of PIDs is quite common as multiplexers and re-multiplexers merge new programs or move programs from one transport stream to another. These machines rely on standard table entries to make PID remapping decision and avoid conflicts. Thus, unless there is zero interference with the transport stream while it is being transmitted to the client, there is a possibility of PID collisions and therefore, it is preferred that the PID is placed within a standard PMT.

Users that have not received the PID for the interactive program may receive the same transport stream and decode the transport stream using a QAM tuner including the program that contains the interactive content. However as the user changes channels using an input device, such as a remote control, the QAM tuner will create a channel listing that uses the lower number PID that is associated with the interactive program information. Thus, rather than being able to watch another user's interactive session, the user will have either no signal output to his display/television or some other message desired by the processing office.

In contrast, the client device of the user that requested the interactive session will receive the transport stream, but the client device either already contains PIDs for accessing the interactive components, can access the PID for the interactive components in the transport stream or the client device contains a program to automatically skip the lowest PID or recognizes a private descriptor. As a result, the client device will automatically access the proper video component. The client device may be a set-top box, QAM tuner, cable card, or other decoder capable of storing a program.

It should be recognized that an interactive program may contain PIDs for multiple interactive sessions along with one or more misdirection PIDs. Thus, multiple subscribers may access the same program and associated channel, but will see different output. The video elementary stream for each PID will be part of the interactive components for a separate requesting subscriber. Thus, one program will contain multiple elementary streams wherein the different elementary streams provide interactive content for different subscribers.

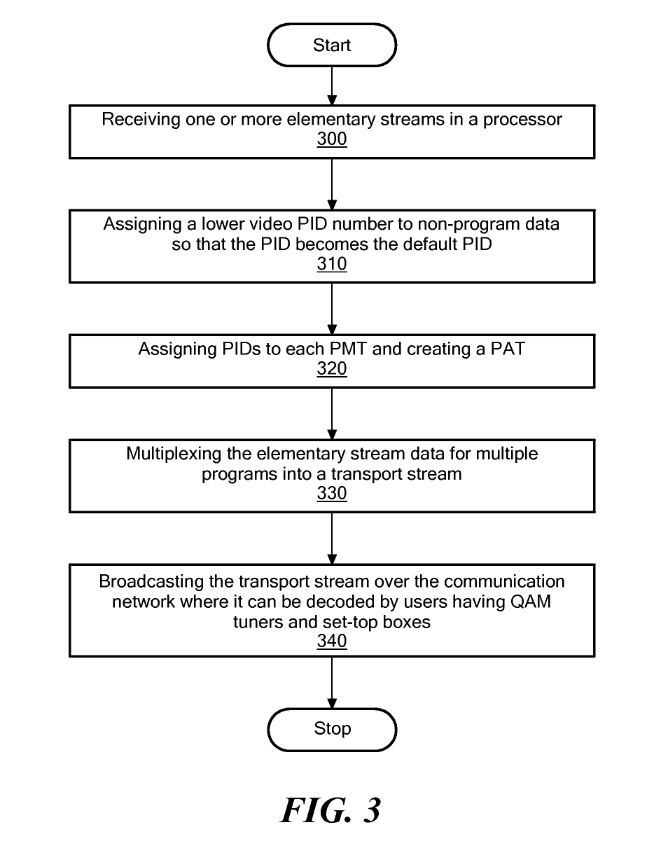

FIG. 3 is a flow chart teaching one methodology for creating a transport stream having PID obfuscation. First one or more elementary streams are received in a processor 300. The elementary streams are grouped according to programs. The elementary streams may be pushed to the processor or requested by the processor. The processor then assigns PIDs to each of the elementary streams. Each category of elementary stream (e.g. audio, video, data) for a program is grouped together and assigned a different PID, wherein the lowest number PID for a given data type (audio, video, etc.) will be decoded by a QAM tuner and output to a display or audio playback device. The receiving processor or another logical processing device creates the PMT for each program. For a program that is to be obfuscated to a clear QAM tuner, the processor assigns at least a video PID with a lower PID number to non-program content than the currently assigned lowest video PID for the actual program content 310. If there are no lower PID numbers than the already assigned number, the PID for the video program will be reassigned to a higher numerical PID and the lowest number PID will be associated either with non program content video data that is not associated with the program content or with no data. By associating the PID with data, QAM tuners that contain logic that search for data before defaulting to the lowest PID, will automatically default to the PID because of the presence of the data. Once the PMT for each program is created, the processor assigns PIDs to each PMT and creates a PAT 320. The PAT is assigned PID 0. The processor then multiplexes the data into a transport stream 330. The transport stream is then broadcast over the communication network where it can be decoded by users having QAM tuners and set-top boxes 340.

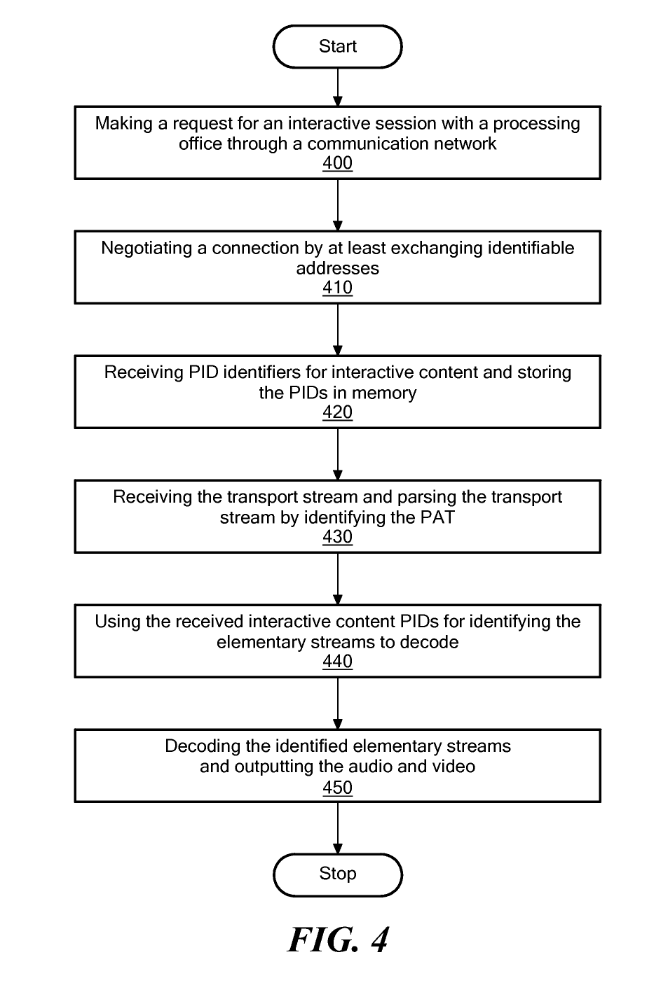

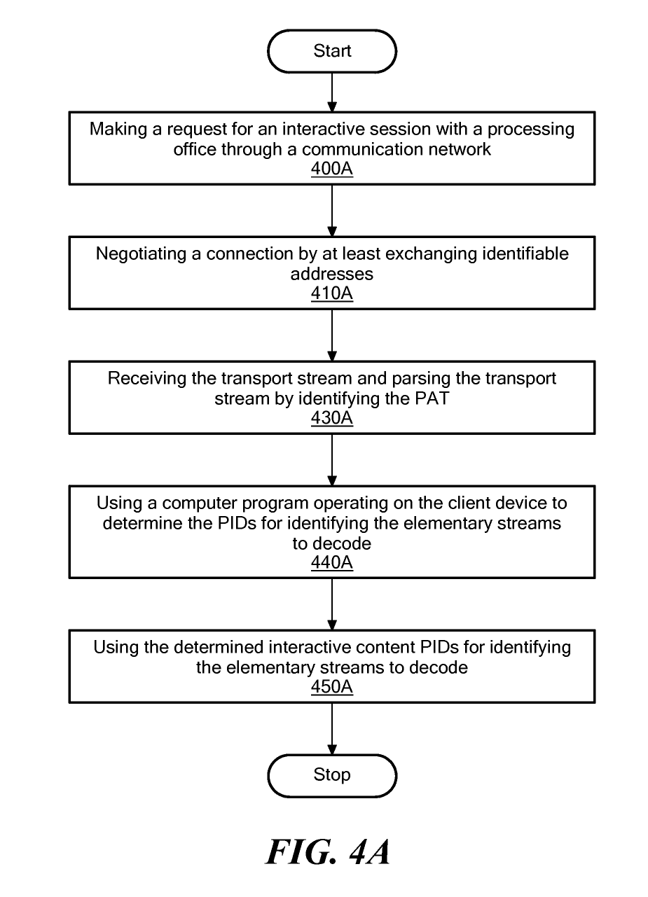

FIG. 4 is a flow chart showing how a client device of a subscriber that requests an interactive session decodes the transport stream to identify, decode, and view the interactive content. First, a client device makes a request for an interactive session with a processing office through a communication network 400. In response, the processing office assigns a processor and hands off communications to the assigned processor. The client device and the processor negotiate a connection by at least exchanging identifiable addresses 410. After the connection is established, the processor communicates with the client device and provides one or more PID identifiers for identifying the elementary streams to be decoded containing the interactive content. The client device receives the PID identifiers and stores the PIDs in memory 420. In general, there would be at least two PIDs, a video PID and an audio PID. The processor provides this information to a multiplexing processor at the processing office that creates the transport stream. The assigned processor also responds to requests for interactive content. The interactive content is generated based upon splicing together separate MPEG sources and using MPEG objects according to patent applications Ser. No. 12/008,697 entitled Interactive Encoded Content System including Object Models for Viewing on a Remote Device and Ser. No. 12/008,722 entitled MPEG Objects and Systems and Methods for Using MPEG Objects both of which were filed on Jan. 11, 2008 and are incorporated herein be reference in their entirety. The process of creating the interactive content employs one or more processors including the assigned processor. Based upon the request for interactive content, the assigned processor will retrieve a file that contains a frame layout. In the frame layout, various MPEG objects are referenced (e.g. button objects, media player objects, pull-down menu objects etc.). The assigned processor requests the content associated with the frame layout and accesses the MPEG objects and their associated MPEG graphical data and functional code. In some embodiments, the assigned processor passes the MPEG graphical data to a stitcher module that stitches together the MPEG graphical data based in part upon the frame layout. The output of the stitcher is a plurality of MPEG video frames. The MPEG video frames form an MPEG elementary stream. The MPEG elementary stream is then defined as part of a program and the program data is multiplexed together with other program data. The program data may be from multiple interactive sessions along with broadcast channels, premium (i.e. encrypted) channels and on-demand programs. The resulting MPEG transport stream is modulated and distributed into the communication network. The client device receives the transport stream and parses the transport stream by identifying the PAT 430. The client device then uses the received interactive content PIDs previously stored in memory for identifying the elementary streams to decode 440. The client device then decodes the identified elementary streams and outputs the video and outputs the audio for the interactive content 450 to a display and speaker. This process repeats until the interactive session is completed. Thus, the client device does not decode the decoy PIDs for the desired program, but rather decodes the PIDs that were sent by the assigned processor.

In an alternative embodiment, as shown in the flow chart of FIG. 4A the processing office does not send to the client device the PID for the interactive content after an interactive session is requested and a connection is negotiated 400A, 410A. Rather in this embodiment, when the client device receives a user request for interactive content, a program operating on the client device determines the PID for the interactive content 430A. This program either interrupts/replaces the standard program on the client device, so that the client device does not default to the decoy PID or the program becomes part of the standard operating system of the client device. The program selects the interactive content PID based upon an algorithm. The algorithm may be as simple as selecting the second PID or skipping the lowest PID for a particular stream type (e.g. video, audio) The algorithm may also be more complex. For example, the computer program on the client device may maintain an assigned PID that identifies all interactive content associated with the client device. Other algorithms that may be used by the client device include employing a counter that increments the PID each time that an interactive session is requested and then transmits the incremented PID to the processing office for use in creating the PMT. Although various algorithms have been proposed, other algorithms may also be used and the described algorithms should not be viewed as a requirement of the invention.

After the PID has been determined and used by the processing office in creating the PAT, the processing office transmits the transport stream to the client device. The client device receives the transport stream and identifies the PAT and the appropriate PMT. 430A. The client device uses the computer program to locate the appropriate PID for the interactive content. 440A. Once the interactive content PID is determined, the client device uses the PID to parse the transport stream and locate the appropriate elementary stream associated with the PID. 450A The client device decodes the elementary stream and then outputs the interactive content to the user's display device.

Although embodiments of the invention have been described as a series of method steps occurring in a particular order, it should be recognized by one of ordinary skill in the art that various steps may be performed in a different sequence without deviating from the intent of the invention. The order of the steps presented in the flow charts should not be construed as limiting.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A method for adding a decoy identifier to a non-encrypted program so that a digital tuner does not decode and present a true component for the program, the method comprising:
creating a transport stream containing a program map table for the program wherein the program map table contains the decoy identifier and an identifier for the true component; and
distributing the transport stream over a communication network to a plurality of televisions including at least one television that has an associated digital tuner that identifies the decoy identifier and attempts to present a decoy component associated with the decoy identifier without presenting the true component.

2. The method according to claim 1, wherein
the decoy identifier is associated with no data and has a relatively lower value than the identifier of the true component of a particular stream type wherein the decoy component is a null set.

3. The method according to claim 1, wherein the decoy identifier is the first identifier of a particular stream type in the program map table.

4. The method according to claim 1, wherein
the decoy component for a particular stream type is associated with data and the decoy identifier for the particular stream type has a relatively lower value than the identifier of the true component for the particular stream type.

5. The method according to claim 1, further comprising:
creating a program association table containing a listing of identifiers for each program map table.

6. The method according to claim 1, wherein the digital tuner is a QAM tuner.

7. The method according to claim 1, further comprising:
decoding the transport stream with a digital tuner wherein the digital tuner locates the decoy identifier and decodes the decoy component associated with the decoy identifier and presents the decoy component for display on an associated television;
wherein the true component is not decoded.

8. A computer program product having computer code on a computer readable storage medium for use with a computer for adding a decoy identifier to a program map table for a program so that a digital tuner does not decode and present a true component for the program, the computer code comprising:
computer code for creating a transport stream containing a program map table for at least one program having a true component the program map table containing a decoy identifier and an identifier for the true component; and
computer code for distributing the transport stream over a communication network to a plurality of televisions including at least one television that has an associated digital tuner that identifies the decoy identifier and presents a decoy component associated with the decoy identifier.

9. The computer program product according to claim 8, wherein
the decoy identifier is associated with no data and has a relatively lower value than the identifier of the true component wherein the decoy component is a null set.

10. The computer program product according to claim 8, wherein the computer code for creating the transport stream places the decoy identifier as the first identifier of a particular stream type in the program map table.

11. The computer program product according to claim 8, wherein
the decoy component is associated with data and the decoy identifier has a relatively lower value than the video identifier of the true component.

12. The computer program product according to claim 8, further comprising:
computer code for creating a program association table containing a listing of identifiers for each program map table.

13. The computer program product according to claim 8, wherein the digital tuner is a QAM tuner or a QPSK tuner or an IPTV receiver.

14. A method for viewing a program on a television, the method comprising:
in a client device within a television network:
receiving an MPEG transport stream;
identifying a program map table for a desired program having at least a decoy identifier for a first stream type and a first identifier for the first stream type;
decoding the component associated with the first identifier; and
outputting the component associated with the first identifier to a display device.

15. A method according to claim 14, further comprising:
for the desired program, receiving the first identifier for the stream type from a processing office;

16. A method according to claim 14, further comprising:
negotiating a connection between the client device and the processing office prior to receiving the first identifier from the processing office.

17. A method according to claim 16, further comprising:
requesting an interactive session with the processing office by the client device.

18. A method according to claim 17, wherein negotiating a connection includes receiving an address of an assigned processor and providing the assigned processor with an identifier for the client device.

19. A method according to claim 15, further comprising:
requesting an interactive session with the processing office by the client device;
wherein requesting an interactive session causes the processing office to send the first identifier to the client device.

20. The method according to claim 14 wherein the first identifier and the decoy identifier are PIDs.

21. The method according to claim 14 wherein at least the decoy identifier for the first stream within the program map table is associated with non-program data.

22. The method according to claim 14 wherein at least the decoy identifier for the first stream within the program map table is associated with no data.

23. The method according to claim 14 wherein the decoy identifier for the first stream type has a lower number than the first identifier for the first stream type.

24. The method according to claim 14 wherein the decoy identifier is the first entry in the program map table for the first stream type.

25. The method according to claim 14, further comprising:
receiving a selection signal for the desired program; and
based on the selection signal determining for the first stream type, the first identifier.

26. The method according to claim 25 wherein determining the first identifier requires the client device to access a program that selects the first identifier and avoids the decoy identifier wherein the client device would without the program default to the decoy identifier.

27. A computer program product on a computer readable storage medium having computer code thereon for use with a client device for viewing a program on a television, the computer program product comprising:
computer code for receiving a first identifier of a program from a processing office;
computer code for receiving an MPEG transport stream;
computer code for identifying a program map table for a desired program having a decoy video identifier and a first identifier;
computer code for decoding the component associated with the first identifier; and
computer code for outputting the component to a display device.

28. A computer program product according to claim 27, further comprising:
computer code for receiving a first identifier of a program from a processing office.

29. A computer program product according to claim 27, further comprising:
computer code for negotiating a connection with the processing office prior to receiving the first identifier from a processing office.

30. A computer program product according to claim 29, further comprising:
computer code for requesting an interactive session with the processing office.

31. A computer program product according to claim 29, wherein the computer code for negotiating a connection includes computer code for receiving an address of an assigned processor and computer code for providing the assigned processor with an identifier for the client device.

32. A computer program product according to claim 29, wherein the computer code for requesting an interactive session causes the processing office to send the first identifier to the client device.

33. The computer program product according to claim 27 wherein the first identifier and the decoy identifier are PIDs.

34. The computer program product according to claim 33 wherein at least the decoy identifier within the program map table is associated with non-program data.

35. The computer program product according to claim 33 wherein at least the decoy identifier within the program map table is associated with no data.

36. The computer program product according to claim 33 wherein the decoy identifier has a lower number than the first identifier.

37. The computer program product according to claim 27, further comprising:
computer code for receiving a selection signal for the desired program; and
computer code for determining the first identifier for the first stream type based on the selection signal.

38. computer program product according to claim 37 wherein determining the first identifier requires the client device to access a program that selects the first identifier and avoids the decoy identifier wherein the client device would without the program default to the decoy identifier.

39. The method according to claim 1, wherein the digital tuner is an IPTV receiver.

40. The method according to claim 1, wherein the digital tuner is a QPSK tuner.

41. The computer program product according to claim 8 wherein the digital tuner is a QPSK tuner.

42. The computer program product according to claim 8 wherein the digital tuner is an IPTV receiver
